(19) United States
(12) Patent Application Publication
(10) Pub. No.: US 2020/0327567 A1
(43) Pub. Date: Oct. 15, 2020

(54) Platform for In-Memory Analysis of Network Data Applied to Market Segmentation with Demand Estimates and Competitor Information

(71) Applicant: Otis Smith, Columbia, MD (US)

(72) Inventor: Otis Smith, Columbia, MD (US)

(73) Assignee: Applied Methods Inc., Columbia, MD (US)

(21) Appl. No.: 16/671,155

(22) Filed: Oct. 31, 2019

Related U.S. Application Data
(60) Provisional application No. 62/753,880, filed on Oct. 31, 2018.

(51) Int. Cl. G06Q 30/02; G06N 3/08

(52) U.S. Cl. CPC G06Q 30/0205; G06N 3/088; G06Q 30/0201

(57) ABSTRACT

A System and method for the application of in-memory analysis of network data applied to spatial market segmentation with demand estimates and competitor information comprising multiple data extractors, a descriptive module, a predictive module, a learning module, at least one application programming interface, and a visualization tool are disclosed. An example of network data is machine readable data that is acquired through an application programming interface. An example of in-memory analysis is the use of in-memory processing and storage objects. A descriptive module is configured to produce market features. An unsupervised learning module is configured to produce market segments and a visualization tool is configured to evaluate one or more market scenarios and to display market features with maps and charts.

### BACKGROUND

### Field of Invention

The present invention relates to pattern classification, and more particularly to determining market segments comprising competitor information and demand forecasts for a sales and operations planning process.

### Background Description

In a sales and operations planning process, information about market segments influences key decisions about marketing, sales, inventory, and product development. For a marketing example, the information about a segment can determine the marketing theme for a campaign. In a sales example, the information about a segment can improve an approach toward acquiring new customers. In an example of inventory management, the information about a segment can influence decisions about product mix. For a product development example, the information about a market segment can influence the selection of features and the prioritization of enhancements.

Sales and operations planning processes usually involve multiple systems including but not limited a customer relationship management system, an enterprise central component system, and a campaign management system. Each system not only controls a functional part of the sales and operations planning process but also requires uniform view of the market to support effective decisions. An in-memory architecture solution with an application programming interface provides the best solution for a distributed systems environment because it can acquire, analyze, and deliver information quickly and efficiently to multiple systems.

Traditional systems that perform market segmentation activities include a database, a user interface for input and visualization, demographic profiles, and behavior profiles maintained in data tables. In this regard, the normal methods include classification trees, k-means clustering, and other statistical methods. In addition to the previous methods, the system usually performs some type of aggregation method before the classification method wherein the results from the aggregation method are stored in a database table and used by the classification method in a subsequent stage of the process.

Although the traditional architecture provides a solution for localized systems, the database server architecture fails to deliver a solution for distributed environments that transfer data across interconnected systems. Furthermore, a closed system remains out of sync with a continuously changing market environment. According to David Marr's interview with Jorn Lyseggen, author of Outside Insight: Navigating A World Drowning in Data, internal data includes “. . . lagging performance indicators—you are seeing shadows of opportunities that you had in the past”. Thus, building segments with stored profile data not only restricts the users view of current possibilities but also enables weak conclusions about true market conditions.

Furthermore, the traditional method provides a solution for a simple business environment where demographic and behavior data alone are enough, it fails offer a solution for complex sales and operations environments where knowledge about projected spending and competitors along with information about the environment where consumers transact business is just as important as knowledge about the consumers behavior and demographic profiles. In addition to the previous failure, the method does not have the capacity to learn from new information and generate new possibilities based on updates. The traditional method is restricted to both the user's input and the static profiles that are prepared, loaded and maintained in a database. Without the capacity to generate new information from updates in the market, the method and its outcomes will fail to provide the user with the best information to make decisions in an intricate business environment.

### SUMMARY

A platform for in-memory analysis of network data applied to market segmentation with demand forecasts and competitor information comprising data extractors to acquire current data from application programming interfaces (APIs) and file transfer protocol servers (FTPs), further comprising in-memory spatial objects to maintain data from the APIs and FTPs; a descriptive statistical module; a predictive module; in-memory spatial objects to maintain results from both the predictive module and the descriptive module; an unsupervised learning module configured to extract market features; an unsupervised learning module configured to build market segments; in-memory spatial objects to maintain the market segments comprising competitor information and demand forecasts; a scheduling component; a controlling procedure that coordinates the activities of the aforementioned components in communication with the scheduling component; an API that delivers the results to other systems; and a visualization tool.

A method for harmonizing internal product data with external spatial market data including but not limited to consumer spending, consumer demographics including but not limited to income; wealth; poverty; language; housing conditions; age; gender; race; population totals; household totals; consumer behavior including but not limited to shopping; internet usage; brand preferences; psychographics, and competitors including but not limited to business count, employee totals, and revenue totals into a single view of industry information that includes layers for local market conditions, state market conditions, and national market conditions.

A method for descriptive statistical analysis comprising many measures including but not limited to the calculation of probabilities, minimums, maximums, and other statistical measures wherein calculation of probabilities further comprises the disaggregation of national data to state and local layers.

At least one, method for forecasting demand comprising future consumer spending within the local layer, wherein projections further comprise relationships between the spending and other variables and the use of product price data to transform the projected spending value into a projected quantity.

A method for unsupervised learning comprising a stage for feature selection of market conditions that influence a product's performance and a stage that builds a topographic representation of the target market segment and one or more external market segments, wherein stage for feature selection further comprises data from local, state and national layers and wherein stage for topographic representation of target market segment further comprises a mixture of spending projections in currency and quantity, competitor information, consumer demographics as defined in an earlier section, consumer behavior as defined in an earlier section, and consumer psychographics.

A computer readable program when executed causes the controlling procedure to execute the steps of acquiring new data from source APIs, harmonizing spatial market data with a company's product data, describing and disaggregating spatial market data, forecasting demand, learning the factors that influence product behavior, and forming a topographical representation of the target segment and external segments.

These and other features and advantages will become apparent from the following detailed description of illustrative embodiments thereof, which is to be read with the accompanying drawings.

### BRIEF DESCRIPTION OF DRAWINGS

FIG. 1 is block/flow diagram showing a method for producing spatial market segments with demand estimates and competitor information in accordance with the present principles;

FIG. 2 is block/flow diagram showing a system for producing spatial market segments with demand estimates and competitor information in accordance with the present principles;

FIG. 3 is a block/flow diagram showing a method for producing spatial market segments with demand estimates and competitor information based on descriptive analysis, statistical forecasting, and unsupervised learning framework in accordance with the present principles;

FIG. 4 is a block/flow diagram showing a high-level overview of the data flow for producing spatial market segments with demand estimates and competitor information in accordance with the present principles;

FIG. 5 is a block/flow diagram showing a high-level overview of the data hierarchy for producing spatial market segments with demand estimates and competitor information in accordance with the present principles;

FIG. 6A is a block/flow diagram of a visualization tool which shows a summary of the market segmentation results in accordance with the present principles; and

FIG. 6B is a block/flow diagram of a visualization tool which shows a dashboard with a table summary of the top market features, a chart of market features and values, and a map of the spatial segments in accordance with present principles.

### DETAILED DESCRIPTION

A methodology for classifying market conditions to determine the associations between demand for a product and consumer attributes within the context of a competitive location is provided according to the present principles. A visualization tool may also be provided for exploring the associations between demand and multiple consumer attributes. A method for classifying market conditions to determine associations between demand for a product and multiple consumer attributes within the context of a competitive location may include extracting data from multiple data sources, harmonizing data from multiple sources, describing market features, forecasting consumer spending for a given product category, selecting market features associated with demand for a product category, building spatial market segments, delivering the spatial market segments to a visualization tool through an application programming interface, and visualizing the spatial market segmentation.

An integrated spatial data model may be constructed at multiple levels of granularity for describing market conditions associated with demand for a given product category. Features that may be employed for building the integrated spatial data model may include product price, product cost, product sales unit of measure, demographic data, psychographic data (e.g. people who say that buying American is important), shopping behavior (e.g. people who eat at Panera Bread), wealth data, tapestry clusters (e.g. millennials living in urban areas with technology jobs), and relevant business information. Thorough classifications and associations may be constructed from the integrated spatial model by using unsupervised learning algorithms (e.g. self-organizing maps).

The visualization system for analyzing the classifications and associations between demand and consumer behavior may include one or more of a scenario-based representations for market segmentations, a drop down menu of available scenarios that can include multiple zip codes, one or more tables which may display the top segments by amount of demand, one or more charts which may display associations between features within a segment, one or more charts which may display demand history and forecast, and one or maps which may display the locations of the market segments with a pop-up window that includes information about the segment. Given the involvement of a forecast with descriptive market features, the present invention may not only reveal future downturns and accelerations in demand months ahead of the event, but also show information that may explain the downtown or acceleration.

Determining spatial market segmentations with associations between demand and consumer attributes is beneficial for supply chain planning, inventory control, marketing, and sales. For example, a demand forecast may be employed to improve corporate forecasting processes restricted to internal sales data. Furthermore, if a company has a new product without sales history, supply chain planning and marketing can use the data for similar products in the market to evaluate growth opportunities for local, regional, and national areas.

External spatial data offers information that can improve the sales and operations planning process. Intuitively, if supply chain planning, sales, and marketing personnel have a better understanding of market conditions and their associations with the sales for a product, then they will produce better plans and forecasts. Better plans and forecasts enable optimal inventory levels and enhanced customer service. In other words, an integrated data model comprising external spatial data and internal product data ensures better outcomes than a traditional sales and operations planning process that is restricted to anecdotal use of external data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

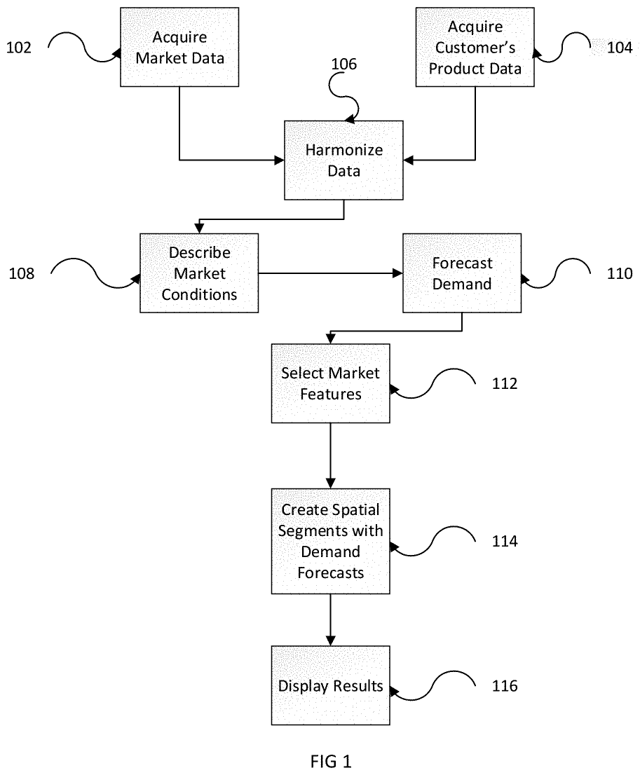

Referring now to the drawings in which like numerals represent the same or similar elements and initially to FIG. 1, a block/flow diagram illustratively showing a method for producing spatial market segments with demand estimates and competitor information 100 in accordance with the present principles is shown. In one embodiment, a market data extractor 102 and a customer product data extractor 104 may be constructed for acquiring spatial data. The harmonization module 106 combines the data from the market 102 with data from a customer's internal system 104. In contrast with traditional market segmentation methods, the harmonization module integrates behavioral data with spending data. A descriptive model emerges from block 108 by applying statistical methods to the harmonized spatial model 106. Following the descriptive, a demand forecast may be obtained in block 110.

In one embodiment, an unsupervised learning method may be constructed in block 112 to select the features that are associated with demand/spending for a given product category, and this process may be repeated for all available product categories and zip codes. The data that is input when building the spatial market segments 114 may include a subset of features from the feature selection block 112 and may use an unsupervised learning method to build a topographical layer of the spatial segments with demand forecasts.

In one embodiment, a visualization tool 116 may enable the analysis of multiple scenarios wherein a single scenario comprises at least one product category and one zip code. The results may be displayed in block 116 on a display device that includes the capacity to display spatial information on a map.

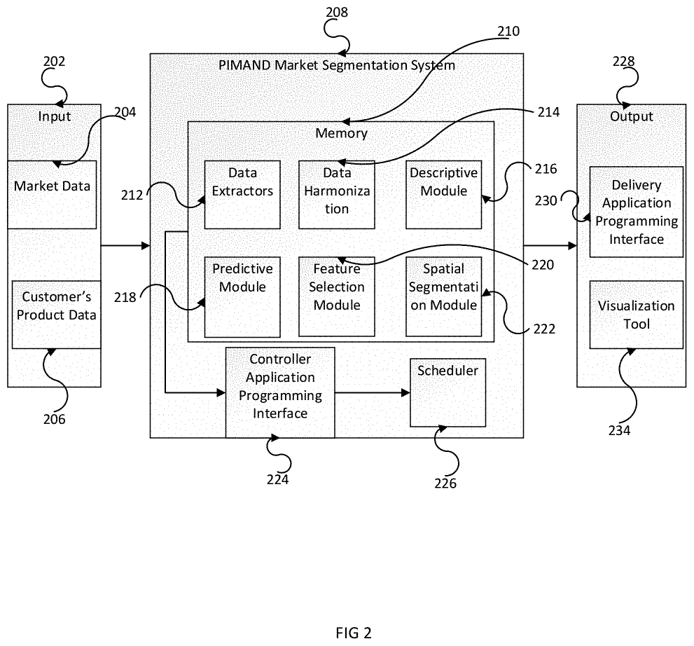

Referring to FIG. 2, a computer system for producing spatial market segments with demand estimates and competitor information 200 is illustratively shown according to one embodiment of the present principles. In one embodiment, the input 202 to the system may be market data 204, wherein market data may include demographics, psychographics, wealth, shopping behavior, and consumer spending, and the customer's product data 206, wherein the customer's product data may include price, cost, and the sales unit of measure.

In one embodiment, a computer system 208 may include in-memory processing 210 which may have one or more modules for the purpose of building spatial market segmentations with demand forecasts and competitor information. The system may include data extractors 212 having one or methods of extracting data from multiple sources. A harmonization module 214 may be employed to combine spatial data from multiple sources to create an integrated data structure. A descriptive module 216 may be employed to describe market features for the given product category. A predictive module 218 may be employed to forecast demand/consumer spending for the given product category. A feature selection module 220 may deployed to select a subset of features that have strong associations with demand/consumer spending. A spatial segmentation module 222 may be deployed to build a topographical representation of market segments. In one embodiment, a controlling application programming interface 224 may activate all in-memory activities in response to a request from a scheduling module 226.

In one embodiment, the output 228 includes both an application programming interface 230 and a visualization tool 234. The spatial market segments from block 222 may be delivered by the application programming interface 230 into a visualization tool 234. Each input 202 component and output 228 component may be coupled with the system 208 to comprise an automated information pipeline.

In one embodiment, the input data 202 may be extracted from multiple sources according to a variety of time intervals/schedules. Furthermore, input data 202 may be extracted in either a continuous data stream or a discrete batch data set. If the input data 202 updates frequently and the system 208 and the output 228 are coupled together, then the embodiment may enable a real time automated information pipeline.

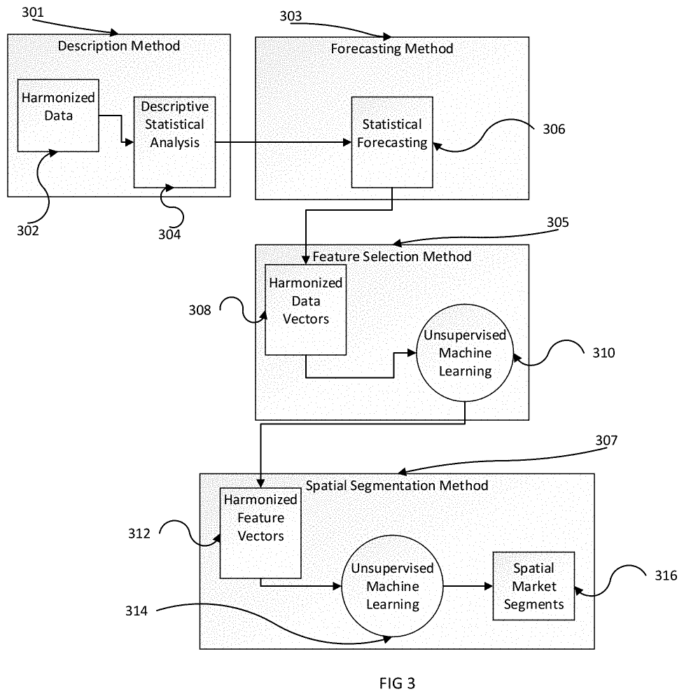

Referring now to FIG. 3, a method for producing spatial market segments with demand estimates and competitor information based on descriptive analysis, statistical forecasting, and unsupervised learning framework 300 in accordance with the present principles is illustratively depicted. In one embodiment, the descriptive method is depicted in block 301, the forecasting method is depicted in block 303, the feature selection method is depicted in block 305, and the spatial segmentation method is depicted in block 307.

In one embodiment, harmonized data 302 is input to a descriptive statistical module 304. A statistical forecasting module 306 may be deployed to construct a demand forecast with input from the descriptive module 304. A harmonized vector set 308 includes behavioral data and demand/spending data that may deployed as input to an unsupervised learning method 310 to extract market features that have strong associations with demand for a give product. The harmonized feature set 312 is a subset of the harmonized vector set 308 and may be deployed as input to a second unsupervised learning method 314 to produce spatial market segments 316.

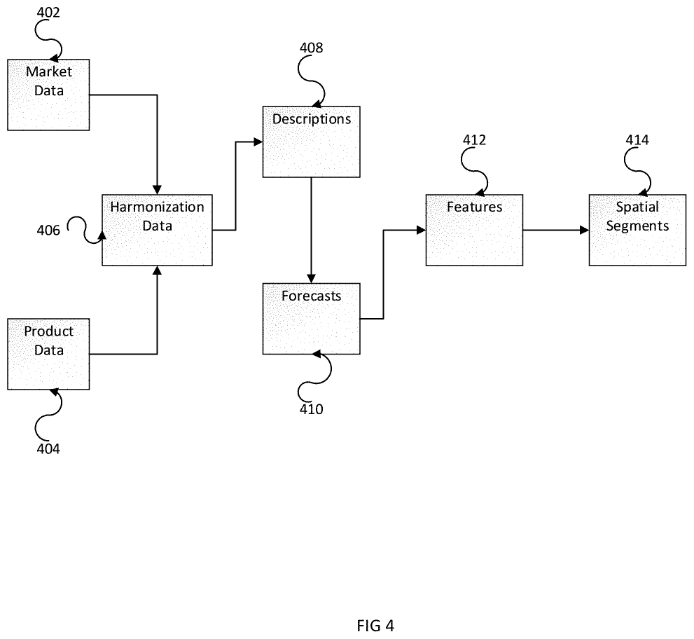

Referring to FIG. 4, a block/flow diagram illustratively depicting a high-level overview of the data flow 400 which may be deployed for producing spatial market segments with demand estimates and competitor information accordance with the present principles. In one embodiment, spatial market data structures 402 may be integrated with spatial product data structures 404 in harmonization block 406 to obtain an integrated data structure for a given scenario. With an integrated data structure 406, a descriptive data structure 408 and a forecast data structure 410 may deployed for producing feature data structures 412. Spatial data structures 414 create topographical layers over the feature data structures 412.

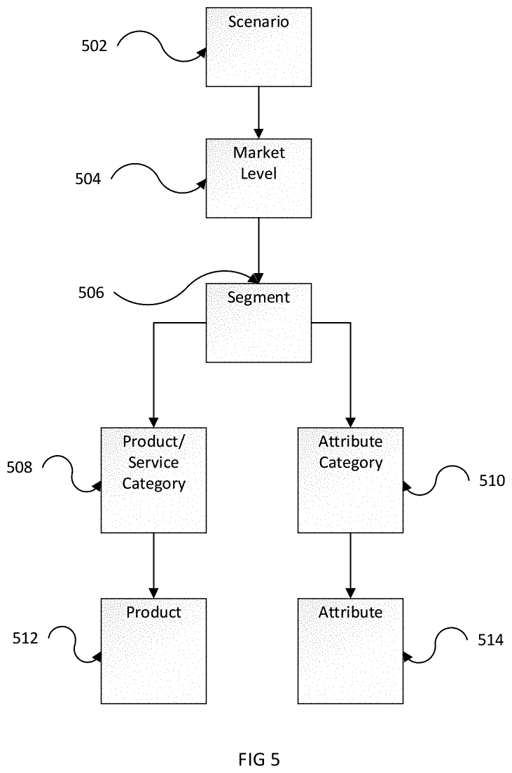

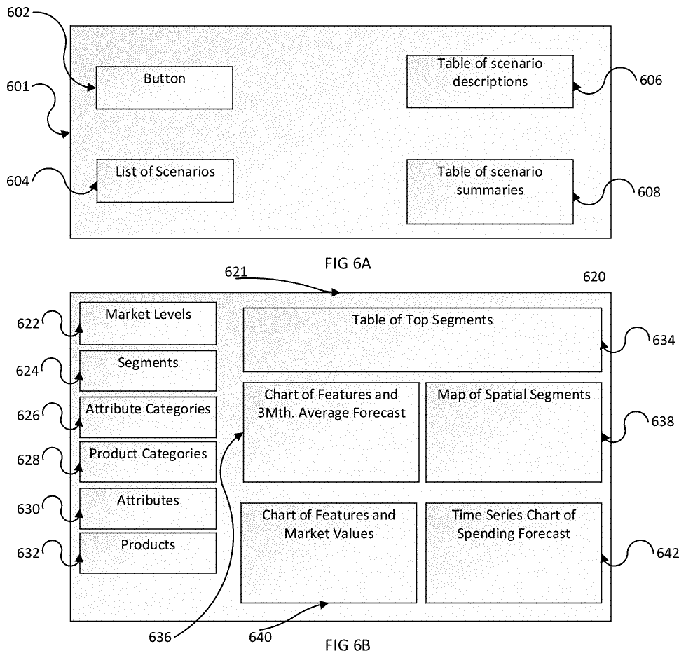

Referring to FIG. 5, a block/flow diagram illustratively depicting a high-level overview of the data hierarchy 500 which may be deployed for producing spatial market segments with demand estimates and competitor information accordance with the present principles. In one embodiment, a scenario entity 502 includes one or more market level entities 504 wherein an example of a market level entity is harmonized market data for a zip code. One or more market level entities 504 may include one or more segments 506 wherein an example of a segment is a set of spatial market features comprising behavioral features, spending features, a forecast, and competitor features. For a scenario 502 and market level 504, a segment 506 may include one or more product/service categories 508, wherein an example of a product/service category is the category video game systems, and one or more attribute categories 510, wherein an example of an attribute category is the category wealth. A product/service category 508 may include one or more products 512 and an attribute category 510 may include one or more attributes 514.

What is claimed is:

1. A system for constructing spatial market segments with demand estimates and competitor information comprising: a controller application programming interface; external spatial market data extractors; internal product data extractors; one or more modules stored in memory and coupled to the controller, further comprising: a data harmonization module that combines market data with internal product data, a descriptive module, a predictive module, a feature selection module, and a spatial segmentation module; a scheduler that communicates with the controller application programming interface; a delivery application programming interface; and a visualization tool.

2. The system as recited in claim 1, wherein the controller application programming interface includes a connection to each module stored in memory.

3. The system as recited in claim 1, wherein the internal data extractors acquire product data wherein product data includes price per unit, cost per unit, and the sales unit of measure from a company's system, and spatial market data extractors acquire data from multiples sources about topics including but not limited to demographics, psychographics, shopping behavior, spending, business establishments in the same industry, employees per business establishment, revenue per business establishment, and tapestry clusters.

4. The system as recited in claim 1, wherein the data harmonization module combines a company's product data with geo-coded market data into an integrated geo-coded data model that includes both behavioral attributes and spending measures.

5. The system as recited in claim 1, wherein the descriptive module is configured to disaggregate data from the harmonization module and show market features at the country, state, and zip code level for company's product category.

6. The system as recited in claim 1, wherein the forecasting module is configured to forecast consumer spending wherein the forecast includes values in the local currency and the primary sales unit of measure for a product category.

7. The system as recited in claim 1, wherein a feature selection module is configured to identify the market features that are associated with demand for a company's product.

8. The system as recited in claim 1, wherein a spatial segmentation module is configured to build clusters wherein clusters comprise at least market features, demand forecasts, and competitor information.

9. The system as recited in claim 1, wherein a delivery application programming interface includes the output from the spatial segmentation module.

10. The system as recited in claim 1, wherein the visualization tool further comprises at least a selection menu of a company's retail/shipping locations that allows the user to generate market segmentations for scenarios with multiple zip codes.

11. The system as recited in claim 10, wherein the visualization tool further comprises at least a table that shows top market features associated with demand for a product, a chart that shows spending by segment, a chart that shows the spending forecast, and a map of the spatial segments.

12. A non-transitory computer readable storage medium comprising a computer readable program, wherein the computer readable program when executed on a computer causes the computer to perform the steps of: extracting data from multiple data sources and passing the data to modules coupled to a controller, wherein modules further comprise: harmonizing geo-coded market data with geo-coded product data, describing market conditions, forecasting consumer spending as demand for a product category, selecting market features associated with demand for a product category, building spatial market segments, delivering the spatial market segments to a visualization tool through an application programming interface, and visualizing the spatial market segmentation.

13. The computer readable storage medium as recited in claim 12, wherein consumer spending forecasts are determined for a local area using one or more statistical forecasting methods.

14. The computer readable storage medium as recited in claim 12, wherein selecting market features associated with demand for a product category uses an unsupervised learning method.

15. The computer readable storage medium as recited in claim 12, wherein building spatial market segments uses unsupervised machine learning to build a topographical layer with demand forecasts and competitor information.
